(19) United States
(12) Patent Application Publication
(10) Pub. No.: US 2026/0104610 A1
(43) Pub. Date: Apr. 16, 2026

(54) OPTICAL FILM COMPRISING COATING LAYER AND BACKLIGHT UNIT INCLUDING THE SAME

(71) Applicant: LMS Co., Ltd., Pyeongtaek-si (KR)

(72) Inventors: Byunghoon LEE, Pyeongtaek-si (KR); Seonghyun JEONG, Pyeongtaek-si (KR); Hoseong KIM, Pyeongtaek-si (KR); Moonho HAM, Pyeongtaek-si (KR); Kilyong KIM, Pyeongtaek-si (KR)

(21) Appl. No.: 19/315,068

(22) Filed: Aug. 29, 2025

(30) Foreign Application Priority Data
Oct. 11, 2024 (KR) 10-2024-0138772

(51) Int. Cl. G02F 1/13357

(52) U.S. Cl. CPC G02F 1/133606

(57) ABSTRACT

An optical film for a display according to one embodiment of the present specification may comprise a base film; a pattern layer including a curved portion formed on the base film; and a coating layer disposed on the pattern layer where the coating layer further includes a plurality of particles continuously arranged on at least a portion of the curved portion of the pattern layer and a filler arranged along the curved portion of the pattern layer and filling the space existing among the plurality of particles.

### CROSS-REFERENCE TO RELATED APPLICATION(S)

This application is based on and claims priority under 35 U.S.C. 119 to Korean Patent Application No. 10-2024-0138772, filed on Oct. 1, 2024, in the Korean Intellectual Property Office, the disclosure of which is herein incorporated by reference in its entirety.

### TECHNICAL FIELD

Various embodiments of the present specification relate to an optical film including a coating layer and a backlight unit including the same.

### BACKGROUND

As display devices are developed, optical films are being developed to prevent images of light or objects from being projected onto the display. For example, display devices used in electronic devices, especially small electronic devices such as smartphones, generally have problems because they reflect objects or light and image displaying from the display device is not accurately transmitted to the user through the optical film. In addition, the use of display devices is increasing not only in smartphones but also in vehicles and various home appliances. Optical films are being developed to reduce the reflectivity of light or objects by utilizing optical films and coating layers applied to the optical films to prevent images of light or objects other than the image displaying from being formed on the display device and to accurately convey information to be displayed on the screen.

In general, optical films are referred to as light control films, etc. Depending on the angle, the pattern effect and reflectivity effect of the optical film are reduced. Although a vapor deposition-type coating is conventionally adopted for the pattern surface of the optical film, an optical film with an improved coating treatment while securing cost and process efficiency is required.

### SUMMARY

An object of the present invention is to provide an optical film including a pattern layer and a coating layer to reduce reflection of light or objects.

According to an embodiment of the invention, an optical film is provided to comprise a base film, a pattern layer including a curved portion formed on the base film; and a coating layer disposed on the pattern layer where the coating layer further includes a plurality of particles continuously arranged on at least a portion of the curved portion of the pattern layer; and a filler arranged along the curved portion of the pattern layer and filling a space existing between the plurality of particles.

In an embodiment, the coating layer further comprises a plurality of coating layers where the plurality of coating layers is stacked in a direction away from the pattern layer for the optical film.

In an embodiment, a refractive index of a portion of the coating layer exposed to air in the plurality of coating layers is lower than a refractive index of the coating layer arranged on the pattern layer for the optical film.

In an embodiment, the coating layer further comprises a first coating layer and a second coating layer where the first coating layer is arranged along the curved portion of the pattern layer; and the second coating layer is disposed on the first coating layer for the optical film.

In an embodiment, the second coating layer further includes an empty space inside the plurality of particles for the optical film.

In an embodiment, a refractive index of the second coating layer is lower than a refractive index of the first coating layer for the optical film.

In an embodiment, the plurality of particles includes an empty space inside the plurality of particles for the optical film.

In an embodiment, the plurality of particles is formed irregularly formed inside the coating layer for the optical film.

In an embodiment, the pattern layer includes at least one of an irregular matte layer, a pyramid pattern, a reversed pyramid pattern, or a prism pattern for the optical film.

In an embodiment, the plurality of particles is arranged along a pattern surface of the pattern layer and a filling ratio defined by a cross-sectional area of the plurality of particles per a unit area of the pattern surface is 40% or more for the optical film.

In an embodiment, the coating layer is extended with a uniform thickness along the pattern surface of the pattern layer for the optical film.

In an embodiment, the curved portion of the pattern layer is repeatedly extended with a first portion wherein the first portion is protruded in a first direction and a second portion wherein the second portion is depressed in a second direction opposite to the first portion for the optical film.

According to another embodiment of the invention, a backlight unit is provided to comprise the optical film, a light source; and an optical sheet where light emitted from the light source is incident to the optical sheet and the optical film is disposed on the optical sheet.

In another embodiment, the backlight further comprises the optical film.

### BRIEF DESCRIPTION OF THE DRAWINGS

The above-described or other aspects, configurations and/or advantages of various embodiments of the present specification may become more apparent from the following detailed description taken in conjunction with the accompanying drawings.

FIG. 1 is, a drawing showing a cross-sectional view of an optical film according to one embodiment.

FIG. 2 is a drawing showing a cross-sectional view of an optical film that enlarges the S region shown in FIG. 1.

FIG. 3 is a drawing showing a cross-sectional view of an optical film according to one embodiment.

FIG. 4 is a drawing showing a cross-sectional view of an optical film according to one embodiment.

FIG. 5 is a drawing showing a cross-sectional view of an optical film according to one embodiment.

FIG. 6 is a conceptual diagram showing an enlarged view of a single particle according to one embodiment of a plurality of particles arranged on the optical film.

FIG. 7 is a cross-sectional view of an optical film including a pattern layer according to an embodiment of the present invention.

FIG. 8 is a drawing showing a cross-sectional view of an optical film including a conventional pattern layer and a coating layer.

FIG. 9 is a drawing showing a backlight unit including an optical film according to one embodiment.

### DETAILED DESCRIPTION

The various embodiments of the present specification and the terms used are not intended to limit the technical features described in the specification to specific embodiments. It should be understood that it includes various modifications of the embodiments, equivalents or substitutes. Regarding the description of the drawing, similar reference symbols may be used for similar or related components. The singular form of a noun referring to a specific configuration may mean one or plural unless explicitly indicated otherwise. In describing the present embodiment, the same name and the same symbol are used for the same configuration and additional explanations will be omitted. In addition, in describing the embodiment of the present invention, it is stated in advance that the same name and the same symbol are used for components having the same function, but they are not substantially completely the same as the prior art.

In the present specification, “A or B”, “at least one of A and B”, or a phrase substantially identical to this may mean any one of them or any possible combination for them. In the present specification, the term “include” or “have” is intended to specify the presence of a feature, number, step, operation, component, part or combination described in the specification, but does not exclude in advance the possibility of the presence or addition of one or more other features, numbers, steps, operations, components, parts or combinations.

The term “first direction” described in the present specification may refer to +Y direction, a direction that is separated with a certain angle or more from +Y-axis to X-axis, ‘height direction’, a ‘direction away from some component’, or a direction substantially the same as these. The term ‘second direction’ may refer to −Y direction, a direction that is separated with a certain angle or more from −Y-axis to X-axis direction, or a direction substantially identical to these. The term “third direction” can refer to +X direction, a direction that is separated with a certain angle or more from X-axis, or a direction that is substantially the same as these. A “certain angle” can include 0 degrees or more and less than 45 degrees. The first to the third direction may not be limited to this and can include both nodirection” and “−direction”. Unless otherwise defined, “X-axis direction” can include both “+X direction” and “−X direction”. Likewise, “Y-axis direction” can include both “+Y direction” and “−Y “Direction”. “Any direction” may include “the same direction as a certain direction” and “a direction substantially the same as or parallel to a certain direction.”

It should be noted that when a component is overlapped (or stacked) with another component in the following description of the present specification, the description of the arrangement relationship in the height direction described above may be applied. However, such description may be applied, but is not limited to, to the arrangement of certain components in a non-perpendicular diagonal or substantially coordinated direction between other components.

An optical film in the present specification may include a pattern layer and a coating layer to reduce reflection of light or objects. However, in case of a vapor deposition process for coating, the low-reflection effect of the coating layer may be reduced due to cracks in the curved matte pattern portion in addition to the cost problem that occurs during the vapor deposition process for coating.

Wet coating may be implemented to deposit particles to a surface of the pattern layer to reduce reflection of objects or light through various embodiments in the present specification. A coating layer can be implemented by wet coating on peaks and valleys of the pattern layer through various embodiments in the present specification. As a result, the coating layer is disposed to include a plurality of particles on peaks and valleys of the coating layer in the optical film.

Wet coating can be applied to a matte pattern to prevent damage to the coating layer and to maintain a low-reflection effect. The optical film having the coating layer with the plurality of particles can maintain a low-reflection effect as well as prevent haze reduction of the pattern layer by maintaining a curved shape. In addition, various effects can be provided, either directly or indirectly, through the present specification.

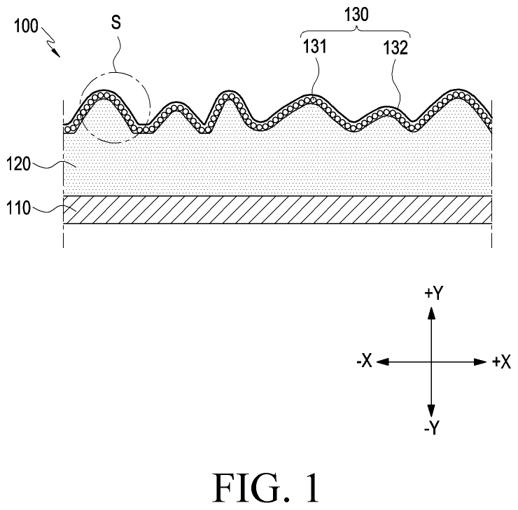

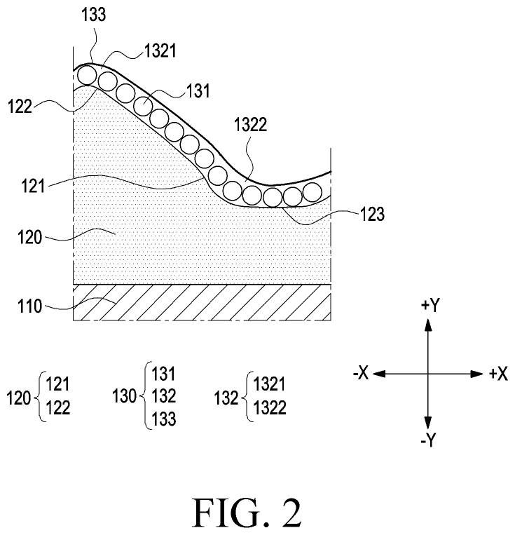

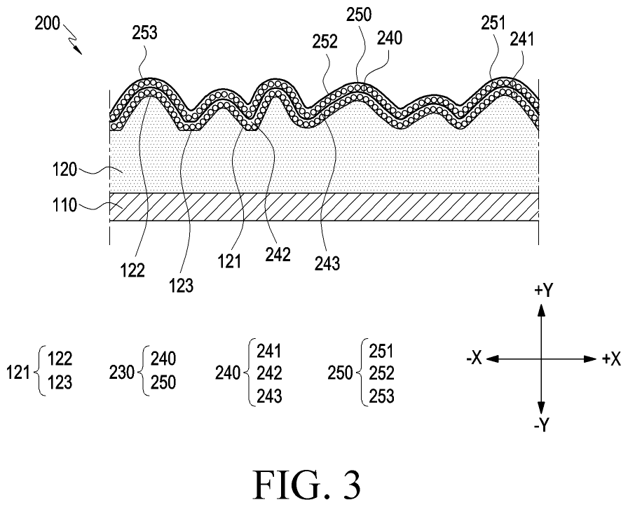

FIG. 1 is a drawing showing a cross-sectional view of an optical film according to one embodiment of the present specification. FIG. 2 is a drawing showing a cross-sectional view of an optical film that enlarges the S region shown in FIG. 1. The components of the optical film described with reference to FIGS. 1 and 2 may be substantially the same as the components described with reference to FIGS. 3 to 7 and FIG. 9.

According to one embodiment, an optical film 100 may include a base film 110. The base film 110 can be disposed on a display (not shown). The base film 110 can be disposed on a basic material (not shown) that constitutes the display cover. Although not shown, an optical sheet including a diffusion layer, an absorption layer, a shielding layer, an adhesive layer, a prism structure, or a reflective layer, etc. or other optical film may be disposed under the base film 110. The base film 110 may be formed of a material capable of transmitting at least a portion of visible light. According to one embodiment, the base film 110 may include at least one of polymer resins such as polycarbonate (PC), acrylate, and polyethylene terephthalate (PET). The base film 110 may have a pattern surface (e.g., 123 of FIG. 2). The base film 110 may have a pattern layer 120 disposed thereon. The base film coated with a coating layer 130 may be named as a first base film (e.g., 110 in FIG. 1). The display (not shown) described in the present specification may be named as one component including a display cover (not shown). The display (not shown) described in the present specification may include a flexible display.

The optical film 100 may include a pattern layer 120 on the base film 110. The pattern layer 120 can be disposed on the base film 110. The pattern layer 120 can be combined with or form a portion of the base film 110. The pattern layer 120 may have an uneven surface roughness. The pattern layer 120 may include a regular or irregular pattern. The pattern layer 120 may be a structure where a plurality of protrusion shapes (e.g., 121 as shown in FIG. 2) facing in a direction are arranged. The pattern layer 120 may include a depressed portion (e.g., 122 in FIG. 2). The pattern layer 120 may include a protrusion portion (e.g., 121 of FIG. 2). The pattern layer 120 may include the protrusion portion extended from the depressed portion. The pattern layer 120 may include the depressed portion extended from the protrusion portion. The pattern layer 120 may include repetitively the depressed portion and the extended portion. The pattern layer 120 may repeat the depressed and the protrusion portion and be extended in a third direction. The pattern layer 120 can be extended in a direction where the base film is extended with a repeated pattern of the depressed and protrusion portions. The pattern layer 120 may include a protrusion portion 122 and a non-protrusion portion 123. The pattern layer 120 may include a curved portion. The pattern layer 120 may be at least one of a matte pattern layer, a pyramid pattern layer, a reversed pyramid pattern layer, or a prism layer. A pattern of the pattern layer 120 can reduce reflection of objects or light from a display (not shown). For example, as protrusion portions of the matte pattern layer are formed, the brightness may not be decreased. Another example, as the haze (Hz) of the matte pattern layer decreases, the total reflected light amount at the interface is increased and the proportion of direct light emission is reduced. Consequently, the overall uniformity of the light emission can be formed. The pattern layer 120 may be referred as a portion of the base film 110. The pattern layer 120 may be referred as an upper layer facing the first direction of the base film 110.

The pattern layer 120 may include a pattern surface 121. The pattern layer 120 may include a first portion 122 protruded in the first direction. The pattern surface 121 may include the first portion 122 protruded in the first direction. The pattern layer 120 may include a second portion 123 depressed in a second direction opposite to the first direction. The pattern surface 121 may include the second portion 123 depressed in the second direction opposite to the first direction. The first portion 122 may be formed convexly toward the first direction. The first portion 122 may include a protruded curved surface toward the first direction. The first portion 122 may be formed as a horn or triangular shape protruding in the first direction. The first portion 122 may be referred as a peak, a convex portion, a protrusion portion, a protruding portion, or substantially the same as such. The first portion 122 can be formed to be extended from the second portion 123. The second portion 123 may be formed concavely toward the second direction. The second portion 123 may include a curved surface formed concavely toward the second direction. The second portion 123 may include a non-protruding portion. The second portion 123 can be formed as a depressed horn or triangular shape facing in the direction. The second portion 123 may be referred as a valley, a concave portion, a depressed portion, a depressed part, a non-protrusion portion, or substantially the same as such. The second portion 123 can be formed to be extended from the first portion 122. The pattern layer 120 may include the first portion 122 and the second portion 123 to be repeated. The pattern layer 120 may be extended to the third direction or the direction where the base film 110 is extended with the repetition of the first portion 122 and the second portion 123. The pattern layer 120 comprises a plurality of first portions 122 or a plurality of second portions 123. The pattern surface 121 may include equally the first portion 122 and the second 123 included in the pattern layer 120. The pattern surface 121 may be identical to a surface of the pattern layer 123. Below, the first portion 122 of the pattern layer 120 may be substantially identical to the first portion 122 of the pattern surface 121. Below, the second portion 123 of the pattern layer 120 may be substantially identical to the second portion 123 of the pattern surface 121.

The optical film 100 may include a coating layer 130. The coating layer 130 can be disposed on the pattern layer 120 of the optical film 100. The coating layer 130 can be extended along the pattern surface of the pattern layer 120. The coating layer 130 can be extended along the first portion 122 and the second portion 123 of the pattern layer 120. The coating layer 130 can be convexly formed in the first direction on a position where the first portion 122 of the pattern layer 120 corresponds. The coating layer 130 can be concavely formed in the second direction on a position where the second portion 123 of the pattern layer 120 corresponds. The coating layer 130 can be formed with a constant thickness on the pattern surface 121. The coating layer 130 may be arranged on the pattern surface 121 and may be formed with a thickness substantially equal to an odd number (2k+1) times the value obtained by dividing a wavelength of incident light by four times the refractive index (n) of the coating layer to have a low-reflection effect. For example, the coating layer can be formed to have a thickness about 101 nm, 303 nm, or 505 nm if light has a wavelength of about 550 nm in the visible light region. In the present specification, however, a thickness substantially equal to an odd multiple may mean a thickness substantially equal to an odd multiple (2k+1) of a value obtained by dividing the average refractive index (n) of the coating layer 130 by four times the average wavelength of visible light. In the present specification, substantially equal to an odd number (2k+1) multiple means that it includes not only a case where the thickness is an odd number (2k+1) times the value of the wavelength of light divided by four times the refractive index (n) of the coating layer 130 but also a case where light has destructive interference, that is, where light is offset due to the difference in the path length of light incident on the coating layer 130 and then, reflected on the pattern layer 120 and the path length of light reflected from the coating layer 130. When light is offset, it may include not only a case where the difference in the paths of light is a multiple of 0.5 wavelengths but also a case where the difference in paths is in or out of a multiple of 0.25 to 0.5 wavelengths. The constant thickness of the coating layer 130 can be defined by Equation 1:

t=(2m+1)×(λ/4×n) [Equation 1]

Here, t refers to a thickness, m refers to any natural number, λ refers to a wavelength of incident light on the optical film, and n refers to a refractive index of the coating layer.

The coating layer 130 may be disposed on the pattern surface 121 thereby maintaining the pattern effect (e.g., HZ effect) of the pattern layer 120 and reducing the reflectivity by depositing particles to the pattern surface 121. The coating layer 130 can have a low-reflection effect while maintaining the pattern effect of the pattern layer 120. The coating layer 130 can reduce the amount of light reflected to the optical film by using a plurality of particles 131. For example, the low-reflection effect can be increased by adjusting the thickness of the coating layer 130 as mentioned above, forming voids, and relatively lowering the reflectivity through silica particles filled with air having a refractive index (n) of 1 in the voids. The coating layer 130 can be deposited on the surface of the pattern surface by wet coating. The wet coating may include inorganic particles and liquid fillers. The particles of the inorganic material may be particles with a void interior. The inorganic particles may be silica. The liquid fillers may be a polymer resin. The liquid fillers can be heated and hardened. The liquid fillers can be cured when exposed to ultraviolet light. Inorganic particles may be included in the coating solution in multiple quantities. The plurality of particles may be included in the liquid fillers in an amount of 1.95 (% or wt %) or more. The content ratio is the volume ratio of particles per unit volume. It can be defined as the ratio of mass per unit mass or the ratio of specific gravity. The coating layer 130 may include the plurality of particles 131. The plurality of particles 131 may be disposed on the first portion 122 of the pattern layer. The plurality of particles 131 may be disposed on the second portion 123 of the pattern layer. The plurality of particles 131 can be arranged continuously along the pattern surface 121 of the pattern layer 120. The plurality of particles 131 may be arranged continuously along the first portion 122 and the second portion 123 of the pattern layer. The plurality of particles 131 can be uniformly arranged along the pattern surface 121 of the pattern layer 120. The plurality of particles 131 can be uniformly arranged on at least a portion of the pattern surface 121 along the pattern surface 121. The plurality of particles 131 may have a filling ratio of 40% or more, which is defined as a ratio of the sum of the cross-sectional areas of the particles arranged on the pattern surface per unit area. In the present specification, the meaning that particles are uniformly arranged is not only the particles are arranged on the pattern surface corresponding to the entire area of the pattern surface but also they are partially evenly distributed. Or, if the particles are arranged with a filling rate of 40% or more, a margin of error of approximately 5% can be allowed.

TABLE 1

| Particle Content | Filling | | Reflectivity Reduction |
|---|---|---|---|
| (%) | Rate (%) | Reflectivity | Ratio (%) |
| 0 | 0 | 4.48 | 0.0 |
| 0.2 | 2.2 | 4.36 | 2.7 |
| 0.4 | 13.0 | 4.18 | 6.7 |
| 0.6 | 17.0 | 3.71 | 17.2 |
| 0.8 | 21.8 | 3.61 | 19.4 |

TABLE 2

| Particle Content | Filling | | Reflectivity Reduction |
|---|---|---|---|
| (%) | Rate (%) | Reflectivity | Ratio (%) |
| 0.95 | 40.4 | 2.7 | 39.7 |
| 1.2 | 61.5 | 2.3 | 48.7 |
| 1.4 | 66.1 | 2.52 | 43.8 |
| 1.6 | 66.9 | 2.23 | 50.2 |
| 1.9 | 76.1 | 2.86 | 36.2 |

Table 1 is a table showing the filling rate, reflectivity, and reflectivity reduction ratio of a plurality of particles arranged on a pattern surface with respect to the particle content according to comparative examples. Table 2 is a table showing the filling rate, reflectivity, and reflectivity reduction ratio of a plurality of particles arranged on a pattern surface with respect to the particle content according to embodiments of the present specification. The reflectivity reduction ratio in Table 1 and Table 2 can be defined as 1−(reflectivity per particle content/reflectivity of uncoated pattern). According to one embodiment of the present specification according to Table 2, when the particle content included in the coating liquid is 0.95% or more, it can be seen that the sum of the cross-sectional areas of the plurality of particles per unit area of the pattern surface is 40% or more. According to one embodiment of the present specification in Table 2, when the filling rate is 40.4% or more, it can be seen that the effect of reflectivity reduction tends to be increasing as the reflectivity reduction ratio is increased according to one embodiment of the present specification.

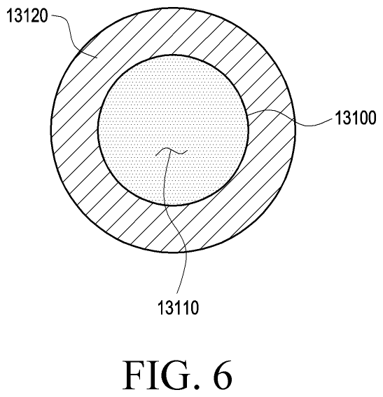

The plurality of particles 131 can be arranged in contact with each other. The plurality of particles 131 are arranged on a position corresponding to at least a portion of the first portion 122 or the second portion 123 along the pattern surface 121 of the pattern layer 120. The plurality of particles 131 may have empty spaces inside each particle (e.g., 13110 shown in FIG. 6). The empty space may be referred as a void or substantially the same as it. The plurality of particles 131 can be arranged on the pattern layer 120 by wet coating deposited on the pattern layer 120. For the wet coating, the plurality of particles 131 can be deposited on the pattern layer 120 in a liquid state. The plurality of particles 131 can be arranged on the pattern surface 121 of the pattern layer 120 to reduce the reflectivity of the optical film 100. At this time, by reducing the reflectivity, the effect of light or objects reflecting off the display is reduced, and thus, information displayed on the screen can be clearly viewed by the user. Particles constituting the plurality of particles 131 are called as “′Nano Particle”, ‘Spherical Particle’, or a name substantially the same as such. The particles constituting the plurality of particles 131 may include at least one of silicon dioxide (SiO₂), titanium dioxide (TiO₂), zirconium dioxide (or zirconia) (ZrO₂), aluminum (III) oxide (Al₂O₃), magnesium fluoride (MgF₂), or tantalum dioxide (TaO₂).

The coating layer 130 may include a filler 132. The coating layer 130 may include spaces between each particle constituting the plurality of particles 131. The filler 132 can be arranged along the pattern surface 121 of the pattern layer 120. The filler 132 can be arranged along the first portion 122 and the second portion 123 of the pattern layer 120. The filler 132 can be protruded in the first direction corresponding to the first portion 122. The filler 132 may include a protrusion portion 1321 corresponding to the first portion 122. The filler 132 may be depressed in the second direction corresponding to the second portion 123. The filler 132 may include a depressed portion 1322 corresponding to the second portion 123. The filler 132 can be placed in the space between the plurality of particles 131. The filler 132 can completely fill the space between the particles constituting the plurality of particles 131. The filler 132 can constitute a surface 133 of the coating layer 130. The filler 132 can include a first surface 133. When a display panel combined with a flexible display moves, the filler 132 can move fluidly together with the plurality of particles 131. Due to the filler 132, the coating layer 130 can prevent damage despite of movement of the flexible display. The filler 132 can support the plurality of particles 131 arranged on the pattern surface 121 of the pattern layer 120. The filler 132 may include resin.

The coating layer 130 can be implemented on the pattern surface 121 of the pattern layer 120 by wet coating by dispersing a plurality of nanoparticles (Nano Particle) (e.g., 131 of FIG. 1) consisted of at least one of materials such as TiO₂, SiO₂, ZrO₂, or Al₂O₃ in a low-reflection coating solution. The surface 133 of the optical film implemented through the wet coating can provide a reflectivity reduction effect. The particles can include other spherical particles. For example, spherical particles having a void formed on the pattern surface 121 of the pattern layer can be dispersed in liquid coating solution and the coating solution can be applied to the pattern surface by the wet coating to implement the coating layer 130.

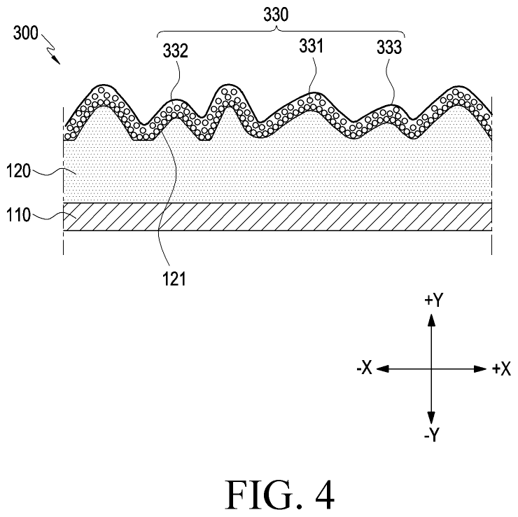

FIG. 3 is a drawing showing a cross-sectional view of an optical film 200 according to one embodiment of the present specification. The components of the optical film 200 described with reference to FIG. 3 may be substantially the same as the components described with reference to FIGS. 1 and 2. The components of the optical film 200 described with reference to FIG. 3 may be substantially the same as the components described in FIGS. 4 to 7 and FIG. 9. Components not described below may be substantially identical to the components described with reference to FIGS. 1 and 2.

Referring to FIG. 3, the optical film 200 according to one embodiment may include a plurality of coating layers 230. The plurality of coating layers 230 can be arranged on the pattern layer 120. The plurality of coating layers 230 can be arranged to be extended along the pattern surface 121 of the pattern layer. The plurality of coating layers 230 may include at least a portion corresponding to the first portion 122 or the second portion 123 of the pattern layer. The plurality of coating layers 230 can be stacked in a direction away from the pattern layer 120. The plurality of coating layers 230 can be stacked in the first direction. The plurality of coating layers 230 may include a plurality of particles 241, 242 and fillers 242, 243. Each of the coating layers 240, 250 constituting the plurality of coating layers 230 may be substantially identical to the coating layer described with reference to FIGS. 1 and 2 (e.g., 130 of FIG. 1).

The plurality of coating layers 230 may include a first coating layer 240 and a second coating layer 250. The first coating layer 240 can be arranged along the pattern surface 121 of the pattern layer 120. The first coating layer 240 may include a plurality of particles 241 and filler 242. The first coating layer may include a first surface 243. The filler 241 of the first coating layer 240 may include the first surface 243. The surface 243 of the first coating layer can be substantially identical to the first surface 243. The second coating layer 250 can be disposed on the first coating layer 240. The second coating layer 250 may be disposed on the first surface 243 of the first coating layer. The first surface 243 may be identical to the surface 243 of the first coating layer. The second coating layer 250 may be extended along the first coating layer 240. The second coating layer 250 can be stacked on the first coating layer 240. The second coating layer 250 may include a plurality of particles 251 included in the second coating layer and a filler 252 included in the second coating layer. The filler 252 of the second coating layer may include a second surface 253. The second surface 253 may be identical to the surface 253 of the second coating layer 250.

A plurality of coating layers 250 may be configured to have different refractive indices with respect to each coating layer (e.g., the first coating layer 252 of FIG. 3). The first coating layer 251 disposed on the pattern surface 121 can be configured to have a relatively higher refractive index than the refractive index of the second coating layer 252. For example, if the value (n) of the refractive index of the first coating layer 251 disposed close to the pattern surface 121 is 1.4 to 1.7, the value (n) of the refractive index of the second coating layer 252 disposed away to the pattern surface 121 may be about 1.2 to 1.4. The refractive index of the coating layer exposed to air (e.g., the second coating layer 252 of FIG. 3) may be smaller than the refractive index of the coating layer unexposed to air (e.g., the first coating layer 251 of FIG. 3) in the plurality of coating layers 250. The coating layer (e.g., 251 of FIG. 3) disposed on the pattern surface 121 may include particles of titanium dioxide (TiO₂). The coating layer exposed to air (e.g., 252 of FIG. 3) may include particles of silicon dioxide (SiO₂). The coating layer exposed to air as described with reference to FIG. 3 (e.g., 252 of FIG. 3) may refer to a coating layer positioned on the upper side among a plurality of stacked coating layers 250. The coating layer (e.g., 251 of FIG. 3) disposed on the pattern surface 121 may mean a coating layer unexposed to air or a coating layer disposed at the bottom among a plurality of coating layers. The first coating layer 240 and the second coating layer 250 described with reference to FIG. 3 may be substantially the same as the coating layer (e.g., 130 of FIG. 1) as described with reference to FIG. 1 and FIG. 2, respectively. The plurality of particles 241, 251 and the fillers 242, 252 included in the first coating layer 240 and the second coating layer 250, respectively, may be substantially the same as the plurality of particles (e.g., 131 of FIG. 1) and the filler (e.g., 132 of FIG. 1) as described with reference to FIG. 1 and FIG. 2.

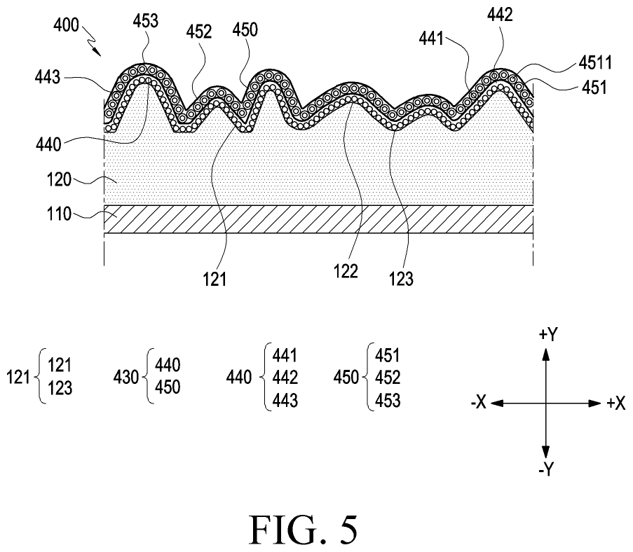

FIG. 4 is a drawing showing a cross-sectional view of an optical film 300 according to one embodiment of the present specification. The components of the optical film 300 described with reference to FIG. 4 may be substantially the same as the components described with reference to FIGS. 1 to 3. The components described with reference to FIG. 4 may be substantially the same as the components described with reference to FIGS. 5 to 7 and FIG. 9. Below, components not described may be substantially identical to the components described in FIGS. 1 to 3.

Referring to FIG. 4, an optical film 300 according to one embodiment may include a coating layer 330. The coating layer 330 may include a plurality of particles 331 and a filler 332. The plurality of particles 331 can be arranged on the pattern layer 120. Each particle constituting the plurality of particles 331 can be stacked in the first direction. Each particle constituting the plurality of particles 331 may be stacked in a direction away from the pattern layer 120. The particles constituting the plurality of particles 331 may be irregularly stacked in a direction away from the pattern layer 120. The plurality of particles 331 may include a first particle, a second particle and a third particle. The third particle may be disposed on at least a portion of the first particle and at least a portion of the second particle in the direction away from the pattern layer 120. The coating layer 330 not described below may be substantially the same as the coating layer described with reference to FIGS. 1 to 3 (e.g., the coating layer 130 of FIG. 1). The plurality of particles 331 and the filler 332 of the coating layer 330 not described below may be identical to the plurality of particles (e.g., 131 of FIG. 1) and the filler (e.g., 132 of FIG. 1).

FIG. 5 is a drawing showing a cross-sectional view of an optical film according to one embodiment. The particles described with reference to FIG. 5 may be substantially identical to the particles constituting the plurality of particles described with reference to FIGS. 1 to 4. The particles described with reference to FIG. 5 may be substantially identical to the particles constituting the plurality of particles described with reference to FIGS. 6, 7, and 9. Below, the components of the particles not described may be substantially identical to the particles constituting the plurality of particles described with reference to FIGS. 1 to 4.

Referring to FIG. 5, an optical film 400 according to one embodiment may include a plurality of coating layers 430. The plurality of coating layers 430 can be arranged on the pattern layer 120. The plurality of coating layers 430 can be arranged to be extended along the pattern surface 121 of the pattern layer. The plurality of coating layers 430 may include at least a portion of corresponding to the first portion 122 or the second portion 123 of the pattern layer. The plurality of coating layers 430 can be stacked in a direction away from the pattern layer 120. The plurality of coating layers 430 can be stacked in the first direction. The plurality of coating layers 430 may include a plurality of particles 441, 451 and fillers 442, 443. The particles constituting the plurality of particles (e.g., 451 as shown in FIG. 5) may include empty spaces (or voids) 4511 within the particles. Each of the coating layers 440, 450 constituting the plurality of coating layers 430 may be substantially identical to the coating layer described with reference to FIGS. 1 and 2 (e.g., 130 of FIG. 1).

The plurality of coating layers 430 may include a first coating layer 440 and a second coating layer 450. A first filler 441 of the first coating layer 440 may include a first surface 443. The surface 443 of the first coating layer may be substantially identical to the first surface 243. The first coating layer 440 described with reference to FIG. 3 may be substantially identical to the first coating layer 240. The second coating layer 450 may be disposed on the first coating layer 440. The second coating layer 450 may be disposed on the first surface 443 of the first coating layer. The second coating layer 450 may be extended along the first coating layer 440. The second coating layer 450 may be stacked on the first coating layer 440. The second coating layer 450 may include a plurality of particles 451 included in the second coating layer and a filler 452 included in the second coating layer. The plurality of particles 451 of the second coating layer 450 may include empty spaces (or voids) 4511 inside the particles. The arrangement of the first coating layer 440 and the second coating layer 450 described with reference to FIG. 5 may not be limited thereto. For example, the plurality of particles 451 including the empty spaces inside the particles may be included in the first coating layer 440. The first coating layer 240 and the second coating layer 250 described with reference to FIG. 5 may be substantially the same as the coating layer (e.g., 130 of FIG. 1) described with reference to FIG. 1 and FIG. 4, respectively. The plurality of particles 241, 251 and the fillers 242, 252 included in each of the first coating layer 240 and the second coating layer 250 may be substantially the same as the plurality of particles (e.g., 131 of FIG. 1) and the filler (e.g., 132 of FIG. 1). The empty spaces (or voids) 4511 formed inside the particles may be substantially the same as the empty spaces (or voids) 13100 described with reference to FIG. 6.

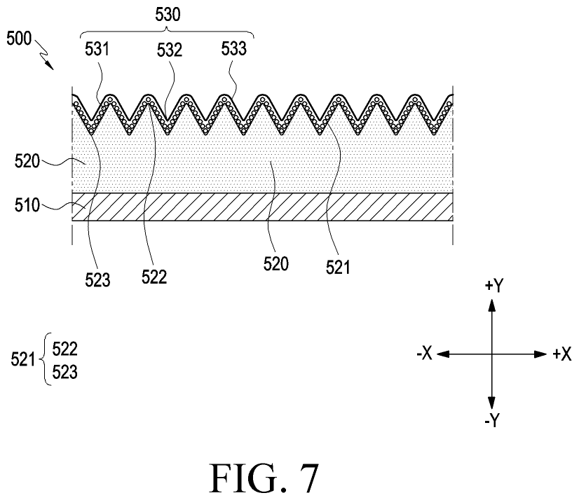

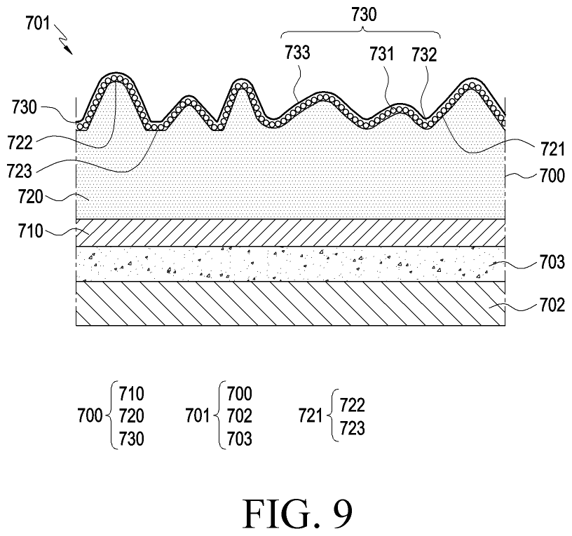

FIG. 6 is a diagram according to one embodiment of the present specification. This is a conceptual diagram magnified of a single particle according to one embodiment of a plurality of particles arranged on an optical film. The particles described with reference to FIG. 6 may be substantially identical to the particles constituting the plurality of particles described with reference to FIGS. 1 to 5. The particles described with reference to FIG. 6 may be substantially identical to the particles constituting the plurality of particles described with reference to FIGS. 7 and 9. Below, the components of the particles not described may be substantially identical to the particles constituting the plurality of particles described with reference to FIGS. 1 to 5.

A particle 13100 with reference to FIG. 6 constituting the plurality of particles (e.g., 131 of FIG. 1) is shown as a circle for convenience of explanation, but is not necessarily limited to this and may include shapes such as oval and irregular circle. The particle 13100 may contain an empty space (or a void) 13110 inside the particle. The particle 13100 may include a shell (outermost shell) 13120 surrounding an internal empty space (or a void) 13110. The particle 13110 may be composed of silicon dioxide (SiO₂). The particle 13100 can be filled with air in its internal empty space 1311. The particle 13100 can be configured to have a refractive index (n) of about 1.45. Because the air with a refractive index (n) of 1 filled in the internal empty space 13110 of the particle 13100 has a lower refractive index (n) than the material (e.g., silicon dioxide (SiO₂)) that composes the particle 13100, it can reduce the average refractive index (n) of the entire particle 13100. The particle 13100 can reduce the average value of the refractive index (n) by controlling the ratio of the air and the particle 13100 occupying the internal empty space 13110. For example, when the refractive index of silica (SiO₂) of the particle 13100 is about 1.45, the particle 13100 with an average refractive index (n) of approximately 1.36 can be formed by controlling the ratio of the air occupying the particle 13100. When light passes the particle 13100 where the internal empty space 13110 is filled with the air with a relatively low refractive index, the average refractive index (n) can be reduced as the optical path is changed and thus, the light repeatedly passes between the air and the particle 13100. The description of the particle 13100 not described below may be the same as the particle constituting the plurality of particles described with reference to FIGS. 1 to 5.

FIG. 7 is a cross-sectional view of an optical film including a pattern layer according to one embodiment of the present specification. The components of the optical film described with reference to FIG. 7 may be substantially the same as the components described with reference to FIGS. 1 to 6. The components of the optical film described with reference to FIG. 7 may be substantially the same as the components described with reference to FIG. 9. Below, components of the optical film not described may be substantially identical to the components described with reference to FIGS. 1 to 6.

Referring to FIG. 7, a pattern layer 520 of an optical film 500 can be disposed on a base film 510. The pattern layer 520 may include at least a pattern of a pyramid, a reversed pyramid, a matte pattern, or a prism-shaped pattern. The pattern layer 520 may include a pattern surface 521. The pattern layer 520 may include a protrusion portion 522 protruding in the first direction. The pattern surface 521 may include the protrusion portion 522 protruding in the first direction. The protrusion portion 522 may be identical to a first portion 522 of the pattern layer 520. The pattern layer 520 may include a depressed portion 523 depressed in the second direction. The pattern surface 521 may include a depressed portion 523 depressed in the second direction. The depressed portion 523 may be identical to a second portion 523 of the pattern layer 520. A coating layer 530 may include a plurality of particles 531 and a filler 532. The coating layer 530 may include a coating surface 533. The filler 532 can form the coating surface 533 of the coating layer. The optical film 500 may include the coating layer 530 on the pattern layer 520. Components of the optical film 500 not described below may be substantially the same as the components described with reference to FIGS. 1 to 5. Components of the optical film 500 not described below may be substantially the same as the components described with reference to FIGS. 1 to 5.

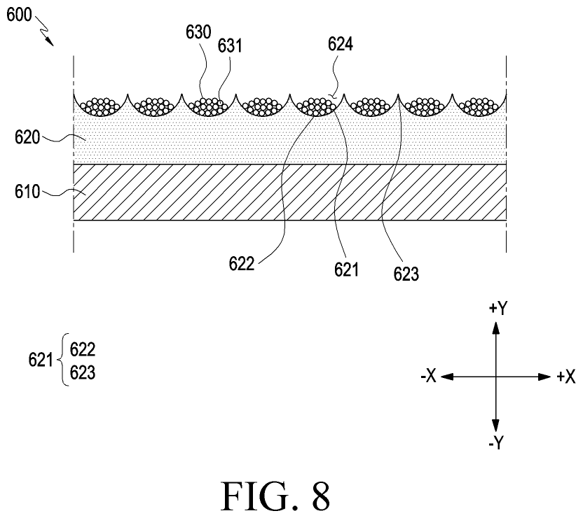

FIG. 8 is a drawing showing a cross-sectional view of an optical film 600 including a conventional pattern layer 620 and a coating layer 630. The conventional pattern layer 620 may include a pattern surface 621. The conventional pattern layer 620 may include a peak (or protrusion portion) 622 protruding in the first direction. The conventional pattern layer 620 may include a valley (or depressed portion) 623 depressed in the second direction. The peaks (or the protrusion portions) 622 and the valleys (or the depressed portions) 623 can be repeatedly extended to form a pattern layer 620. The valley (or depressed portion) 623 can form a recess 624 in the pattern layer 620. The coating layer 630 can be disposed on the pattern layer 620. The coating layer 630 can be applied to the pattern layer 620 by wet coating. The coating layer 630 may include a plurality of particles 631. In the conventional optical film 600, the plurality of particles 631 can be agglomerated in the recess 624 formed in the pattern layer 620. By agglomeration of the plurality of particles 632, the haze effect of the pattern layer 620 of the optical film 600 can be reduced. Due to this, it may be difficult for users to accurately perceive information displayed on the display (not shown).

The optical film according to an embodiment of the present specification (e.g., 100 as shown in FIG. 1) can uniformly arrange the plurality of particles (e.g., 131 as shown in FIG. 1) in the pattern layer (e.g., 120 as shown in FIG. 1) unlike the conventional optical film 600. A backlight unit according to one embodiment of the present specification (e.g., 701 shown in FIG. 9) can uniformly arrange the plurality of particles (e.g., 131 as shown in FIG. 1) in the pattern layer (e.g., 120 as shown in FIG. 1) unlike the backlight unit including the optical film 600 shown in FIG. 8. Because of this, the optical film or the backlight unit according to one embodiment of the present specification may reduce the amount of reflection of an object or light on the display. Because of this, it can accurately convey the screen information displayed on the display to the user. The optical film according to an embodiment of the present specification described with reference to FIGS. 1 to 8 may include a different coating layer (e.g., 130 of FIG. 1) than the optical film described with reference to FIG. 9.

FIG. 9 is an exploded view of a backlight unit including an optical film according to one embodiment. The components of the optical film constituting the backlight unit described with reference to FIG. 9 may be substantially the same as the components described with reference to FIGS. 1 to 7. Components of the optical film not described below may be the same as the components described with reference to FIGS. 1 to 7.

The backlight unit 701 may include a light source 702. The backlight unit 701 may include an optical sheet 703. The backlight unit 701 may include an optical film 700. The optical film 700 may include a base film 710. The optical film 700 may include a pattern layer 720. The pattern layer 720 may include a first portion 722 protruding in the first direction and a second portion 723 depressed in the second direction. The pattern layer 720 may include a pattern surface 721. The pattern layer 720 may include a plurality of the first portions 722 and a plurality of the second portions 723. The pattern surface 721 may include the plurality of the first portions 722 and the plurality of the second portions 723. The optical film 700 may include a coating layer 730. The coating layer 730 can be disposed on the pattern layer 720. The coating layer 730 may include a plurality of particles 731. The coating layer 730 may include a filler 732. Light emitted from the light source 702 of the backlight unit 701 can be exposed to the outside through the optical sheet 703 and the optical film.

The optical film (e.g., 100 of FIG. 1) according to an embodiment of the present specification can be used in combination with not only flat panel displays (FPDs) but also flexible displays.

The optical film according to an embodiment of the present specification (e.g., 100 of FIG. 1) can reduce reflectivity without compromising fluidity even when combined with a flexible display.

The optical film (e.g., 100 of FIG. 1) according to an embodiment of the present specification may include a coating layer having a uniform thickness along the pattern surface 121 of the pattern layer 120. The optical film (e.g., 100 of FIG. 1) according to an embodiment of the present specification may include the coating layer including a plurality of particles, some of which are uniformly arranged on the pattern layer 120.

The problem to be solved in the present specification is not limited to the problem mentioned above and may be variously expanded without departing from the spirit and scope of the present disclosure. Although the detailed description of the present specification has described specific embodiments, it will be apparent to those skilled in the art that various modifications may be made without departing from the scope of the present specification.

What is claimed is:

1. An optical film comprising:
a base film;
a pattern layer including a curved portion formed on the base film; and
a coating layer disposed on the pattern layer,
wherein the coating layer further includes a plurality of particles continuously arranged on at least a portion of the curved portion of the pattern layer; and
a filler arranged along the curved portion of the pattern layer and filling a space existing between the plurality of particles.

2. The optical film of claim 1, wherein the coating layer further comprising:
a plurality of coating layers wherein the plurality of coating layers is stacked in a direction away from the pattern layer.

3. The optical film of claim 2, wherein a refractive index of a portion of the coating layer exposed to an air in the plurality of coating layers is lower than a refractive index of the coating layer arranged on the pattern layer.

4. The optical film of claim 1, wherein the coating layer further comprising:
a first coating layer and a second coating layer,
wherein the first coating layer is arranged along the curved portion of the pattern layer; and
the second coating layer is disposed on the first coating layer.

5. The optical film of claim 3, wherein the second coating layer further includes an empty space inside the plurality of particles.

6. The optical film of claim 4, wherein a refractive index of the second coating layer is lower than a refractive index of the first coating layer.

7. The optical film of claim 1, wherein the plurality of particles includes an empty space inside the plurality of particles.

8. The optical film of claim 1, wherein the plurality of particles is formed irregularly formed inside the coating layer.

9. The optical film of claim 1, wherein the pattern layer includes at least one of an irregular matte layer, a pyramid pattern, a reversed pyramid pattern, or a prism pattern.

10. The optical film of claim 1, wherein the plurality of particles is arranged along a pattern surface of the pattern layer and a filling ratio defined by a cross-sectional area of the plurality of particles per a unit area of the pattern surface is 40% or more.

11. The optical film of claim 1, wherein the coating layer is extended with a uniform thickness along the pattern surface of the pattern layer.

12. The optical film of claim 1, wherein the curved portion of the pattern layer is repeatedly extended with a first portion wherein the first portion is protruded in a first direction and a second portion wherein the second portion is depressed in a second direction opposite to the first portion.

13. A backlight unit including the optical film of claim 1 further comprising:
a light source; and
an optical sheet wherein a light emitted from the light source is incident to the optical sheet and the optical film is disposed the optical sheet.

14. The backlight of claim 13 further comprising: the optical film.
